(19) United States
(12) Patent Application Publication
(10) Pub. No.: US 2008/0229281 A1
(43) Pub. Date: Sep. 18, 2008

(54) METHOD FOR DATA EXCHANGE BETWEEN MEDICAL APPARATUSES

(76) Inventors: Martin Requardt, Nurnberg (DE); Sebastian Schmidt, Weisendorf (DE); Kristin Schmiedehausen, Buckenhof (DE)

Correspondence Address: SCHIFF HARDIN, LLP;PATENT DEPARTMENT, 6600 SEARS TOWER, CHICAGO, IL, 60606-6473, US

(21) Appl. No.: 12/048,370

(22) Filed: Mar. 14, 2008

(30) Foreign Application Priority Data
Mar. 16, 2007 (DE) 10 2007 012 784.9

(51) Int. Cl. G06F 9/44

(52) U.S. Cl. 717/120

(57) ABSTRACT

In a method, a device and a system as well as a modality and a computer program product for integration of a data object into a medical data set, the data object and the medical data set are associated with a patient examination. The medical data set is formatted according to a DICOM standard. The data object is formatted according to a standard other than the DICOM standard. The data object is integrated into the medical data set via at least one shadow group object and a running and/or planned process in connection with the patient examination can be controlled dependent on the integrated data object.

### BACKGROUND OF THE INVENTION

1. Field of the Invention

The present invention concerns a method, a device and a system for integration of a data object into a medical data set, wherein the medical data set is formatted according to the DICOM standard while the data object is formatted according to a standard other than the DICOM standard.

2. Description of the Prior Art

For medical examination of a patient with the use of a medical modality (such as, for example, an x-ray apparatus or a computed tomography system) it is not possible with the present IT infrastructures of hospitals for a treating physician to automatically incorporate or have incorporated patient-relevant information (such as, for example, laboratory values from other or earlier examinations or from other medical examination modalities) into the current examination in order to execute the examination workflow with the use of the medical modality dependent on the additional patient-relevant information in a targeted manner suitable to the patient.

Laboratory values of the patient (see thyroid diagnostics with thyroid values, kidney examinations by means of contrast agents and kidney values, FDG-PET examinations with blood sugar values etc.) must be taken into account in imaging diagnostics such as the acquisition and/or the medical assessment of x-ray images. The laboratory values can sometimes be prepared and obtained only with certain personnel effort and to some extent with time delay. There is additionally no possibility whatsoever to control the medical modality dependent on additional information (for example laboratory values) or to have the examination procedure run automatically with the modality dependent on the additional information.

It would therefore be desirable to have a method and a system in which a treating physician (such as, for example, a radiologist) has simple access to further or earlier patient data when a finding generation should be implemented with the use of a medical modality, or when a finding procedure is in progress, with the further additional patient data originating from another medical modality.

It would likewise be desirable to link generated information of different formats or different standards that are related to a patient, namely to link them such that a faster access can ensue and the linking of the information or embedding of the information in other information can be used to control medical modalities.

### SUMMARY OF THE INVENTION

In accordance with the invention, in a method for integration of at least one data object in at least one medical data set, the data object and the medical data set are associated with at least one patient examination. The medical data set is formatted according to a DICOM standard. The data object is formatted according to a standard other than the DICOM standard. In the inventive method the data object is integrated into the medical data set via at least one shadow group object of the DICOM standard and a running and/or planned process in connection with the patient examination can be controlled dependent on the integrated data object. The shadow group object can be formatted or defined according to the DICOM standard.

The at least one data object can include, for example, one or more laboratory values which, for example, have been generated by an in vitro diagnostic apparatus. Alternatively, the data object can also include a combination of non-DICOM data and/or other patient-specific or examination-specific values or parameters.

In another embodiment, the at least one data object can include values that are provided online in real time, for example from a central database via a network or another modality. For example, the at least one data object can comprise the current value of the pulse beat of a patient which is determined with the aid of a pulse measurement apparatus, wherein the patient is simultaneously located in an acquisition process of a computed tomography apparatus.

The at least one data set can include, for example, comprise one or more medical images (such as, for example, x-ray images) that are generated or picked up by a medical modality. The data set can be defined or formatted according to the DICOM standard.

DICOM is a abbreviation for “Digital Imaging and Communications in Medicine” and represents a worldwide open standard for exchange of digital images in medicine. Both the format for storage of image data and the communication protocol for exchange of the images or, respectively, image data are specified by means of the DICOM rules and regulations. A DICOM object comprises both a DICOM metafile (i.e. a DICOM header or section) and the DICOM pixel data.

DICOM objects or DICOM data are generated by various medical modalities from various medical disciplines and in different departments separated from one another. By medical modality, what is hereby understood is an examination apparatus for generation, acquisition, alteration of medical, patient-related (normally digital) data. A medical modality is accordingly, as already mentioned, a computed tomography apparatus, an x-ray apparatus, a mammography apparatus, an ultrasound apparatus, an endoscope, etc., for example.

The shadow group object can be a static object or a dynamic object. If, for example, laboratory values are generated by an analysis apparatus in a laboratory and the analysis apparatus generates only data which exist in a DICOM-foreign format, these can be introduced into the shadow group object in a first step.

The shadow group object, for example, can be automatically self-acting as an active object and can control its activity itself, or the activity of the shadow group object can be controlled by a user.

The shadow group object, for example, can be generated, activated and controlled by the medical modality which generates a medical data set about the health state of a patient.

A running and/or planned process can be of a medical technology type such as, for example, an x-ray examination of a patient with the aid of an x-ray apparatus. According to the inventive method, DICOM-foreign data (for example laboratory values that exist in a standard other than the DICOM standard) computer network thus be processed further such that this information is used, for example, in order to modify the generated medical data sets (such as x-ray images). Furthermore, the x-ray workflow of the process (i.e. the x-ray apparatus itself and its configuration) as well as, for example, a radiation intensity can therewith also be controlled from the current laboratory value. Such a process can be an examination process of a medical modality, a data processing device (for example for post-processing of image data) and a display of data on a screen. The process can be controlled by the integrated data object.

For example, in a further medical field a blood glucose level that is too high at the point in time of a positron emission tomography (PET) examination with a radiopharmaceutical such as F-fluorine-deoxyglucose (FDG) can lead to the situation that the uptake of FDG in the tissue is too low. This effect can be compensated via the inventive method by a modification of the generated medical data sets (i.e. images) dependent on the determined blood sugar content. The blood sugar content is a laboratory value which exists in a different format than the medical images of the positron emission tomography apparatus that are to be generated. According to one aspect of the inventive method, the laboratory value can be loaded from a database and be used for manipulation of the medical images, or can be integrated into these and displayed on a display system such as a monitor.

In another embodiment of the inventive method, retrieved data objects or data objects integrated into data sets (i.e. laboratory values) can already be used in the planning of an examination with the aid of a modality. For example, a lower contrast agent dose can be suggested or be provided at the modality given altered kidney values.

A simplified incorporation of data or values into a radiological examination process can thus be realized with the invention with only minimal changes to the IT structure of a hospital.

The IT structure can include a PACS system, for example. PACS is the abbreviation for “Picture Archiving and Communication System” and is an image archiving and communication system based on digital data processing systems and networks.

According to a further aspect of the invention, the method is characterized by the at least one data object being converted.

For example, this can be a lossless transfer of a data object of one format into a data set of another format. A DICOM-foreign data object can thus be integrated into a medical DICOM data set. The integration and/or conversion can thereby ensue with the aid of the shadow group object, according to which the data object has been cached, converted and subsequently transferred from the shadow group object to the medical data set. In an alternative embodiment, such a shadow group object can be an integral component of a medical data set generated or to be generated using a medical modality. A dynamic interoperability can thereby be realized.

In a further embodiment of the inventive method the at least one shadow group object accommodates the at last one data object.

The data object can be arbitrarily specified. To accept the data object, the shadow group object which is provided for integration of the data object into the medical data set has an interface designed corresponding to the data object.

In another embodiment it is provided that the medical data set is linked with the integrated data object and/or is stored as a separate object.

For example, by this it can be understood that a data object (such as, for example, a laboratory value) is linked with a medical data set (such as, for example, x-ray images) via pointers by means of a common database. This leads to a lesser loading of storage media in a PACS system.

Moreover, the storage of a data object that was integrated as a separate object into a medical data set can enable a fast access to the desired or relevant information and thus serves to increase the efficiency of an examination process.

The storage of the data object or data objects as a separate object together with the medical data set or medical data sets (i.e. the mutual storage) can also occur on a CD, DVD, etc. and be given to the patient. All relevant information is thus stored centrally on a storage medium and no conversion measures or, respectively, no further additional processes or modules whatsoever are needed for readout of the data since these exist in one format. For example, laboratory values can hereby be stored in one and the same DICOM object, i.e. in one and the same DICOM data set.

In a further embodiment of the inventive method the medical data set with an integrated data object is transferred and/or processed further as a separate object.

A data transfer can therewith be dynamically administered in a PACS system and bottlenecks are avoided.

According to further aspect of the invention, the at least one data object includes at least one laboratory value and/or other non-DICOM-based values.

Non-DICOM-based values can, for example, be numerical values such as basic information acquired in the patient admission for treatment and data such as name, age, address. It is therefore possible in accordance with the invention to also have such information displayed in connection with the medical images given a medical examination at a modality and to store or further process these together.

The at least one medical data set typically includes image data, in particular radiological data.

The medical data set that is generated by the modality is defined according to a DICOM standard.

In another embodiment, the inventive method is characterized by the at least one integrated data object being alternatively automatically displayed and/or further processed together with the medical data set.

The integration of the data object into the medical data set can essentially occur simultaneously with the generation of the medical data sets. A faster and safer examination process can thereby primarily be realized. Furthermore, the examination apparatus (i.e. the medical modality and its workflow) can also additionally be nearly simultaneously influenced.

However, in principle the integration process is not time-limited and the integration can ensue at any arbitrary point in time during or after the generation of the (image) data set.

According to a further aspect of the invention, data or values of the integrated data object can be altered and/or processed further in the framework of the processing of the medical data set.

For example, it is possible for not only is a laboratory value integrated into medical image data displayed on a display but also for the value to lead to an alteration (i.e. manipulation) of the display of the medical image data. An indication of possible problems or dangers is thus automatically provided to the examining physician, which leads to a safer diagnosis.

According to a further aspect of the invention the data of the integrated data object are automatically imported via an interface. Alternatively, a manual data transfer (for example via portable storage media) is provided.

In an alternative embodiment the interface of the inventive method can comprise a shadow group object, wherein the shadow group object is compatible with the medical data set.

A lesser administration effort can therewith be achieved, which leads to a time savings.

The process is advantageously of a medical technology type; and/or is a medical image acquisition; and/or it concerns a display of the data object and/or of the medical data set on a display device; and/or a manipulation of the medical data set; and/or a manipulation of the data object.

For example, format-foreign laboratory values stored in a database can therewith be linked with an associated examination. For example, thyroid values can be used at the point in time of a thyroid scintigraphy or be combined with the image data of this scintigraphy at a later point in time.

A further object of the invention is to provide a device for execution of the inventive method. The advantages, features and alternative embodiments noted in connection with the specification of the inventive method, are also applicable to the inventive device, to the system, to the modality and to the product. The features according to the method are respectively realized in corresponding modules. A device for integration of at least one data object into at least one medical data set is therefore provided, wherein the at least one data object and the at least one medical data set are associated with at least one patient examination. The at least one medical data set is formatted according to a DICOM standard and the at least one data object is formatted according to a standard other than the DICOM standard. The device has at least one data object integration module for integration of the data object into the medical data set via a shadow group object interface and furthermore comprises one control module to control a running and/or planned process dependent on the data object integration module, wherein the process is or can be controlled dependent on the data object, and wherein the process is connected with the patient examination.

The shadow group interface can thereby be defined via the DICOM standard or, respectively, satisfy the DICOM standard. In an alternative embodiment, the shadow group interface can be extended by manufacturer-specific parameters in order to integrate additional data objects into medical data sets.

A signal exchange can occur between the respective modules of the inventive device. The inventive device can be a component of an electronic data processing system such as, for example, a personal computer or a workstation. Alternatively, the device can also be a component of a medical modality. The device according to the invention can be executed in hardware and/or software.

The electronic data processing system thereby comprises components that are known such as, for example, a central processing unit (CPU), mainboard, interfaces for data input or, respectively, navigation devices (such as, for example, a computer keyboard or computer mouse), display interfaces for display devices (such as, for example, a screen), communication ports for the coupling to network structures in the form of network cards, memory modules (RAM, ROM), disk controller, CD-ROM/DVD drive, hard disk, disk drive, etc.

The invention also encompasses a medical modality that includes an inventive device as described above. The medical modality will typically have a display device. For example, a medical modality (as already mentioned) can be an x-ray apparatus, a tomography apparatus, an endoscope, etc. that is fashioned for integration of format-foreign data objects.

The invention also encompasses a medical system having at least one first medical modality which generates a data object and at least one second medical modality which generates the medical data set. The first medical modality is connected in terms of data with the second medical modality for execution of a method for integration of the data object into the medical data set. The data object and the medical data set are associated with at least one patient examination, wherein the medical data set is formatted according to a DICOM standard, and wherein the data object is generated according to a standard other than the DICOM standard. The data object is integrated into the medical data set via at least one shadow group object, and a running and/or planned process which is connected with the patient examination can be controlled dependent on the integrated data object.

The shadow group object can thereby satisfy the DICOM standard or can be defined according to this standard.

The advantages, features and alternative embodiments noted in connection with the specification of the inventive method, are applicable to the inventive device as well as to the inventive system.

The inventive embodiments of the method described in the preceding can also be fashioned as a computer program product that causes a computer to implement the inventive method described above when its program code is executed by a processor.

The invention also encompasses a storage medium that is designed to store the computer-implemented method described in the preceding and is readable by a computer.

Moreover, it is possible for individual components of the method described in the preceding to be executed in a commercial unit and the remaining components in another commercial unit, as a distributed system.

The disclosed features of the inventive method can naturally be arbitrarily combined with one another to achieve further properties.

### BRIEF DESCRIPTION OF THE DRAWINGS

The single FIGURE is an overview schematic representation of an example of the invention.

### DESCRIPTION OF THE PREFERRED EMBODIMENTS

The FIGURE shows an exemplary segment of the method of the invention in an overview schematic representation, as well as some devices of the invention in outline.

A data object 1 is accordingly presented. The data object 1 includes laboratory data or laboratory values 4. The data object 1 with the laboratory values 4 is associated with a patient and was generated in the framework of a medical examination process by a laboratory medical modality. The laboratory medical modality shown in the FIGURE that has generated the data object 1 is, for example, an in vitro diagnostic product (IVD), i.e. an in vitro analysis apparatus 30.

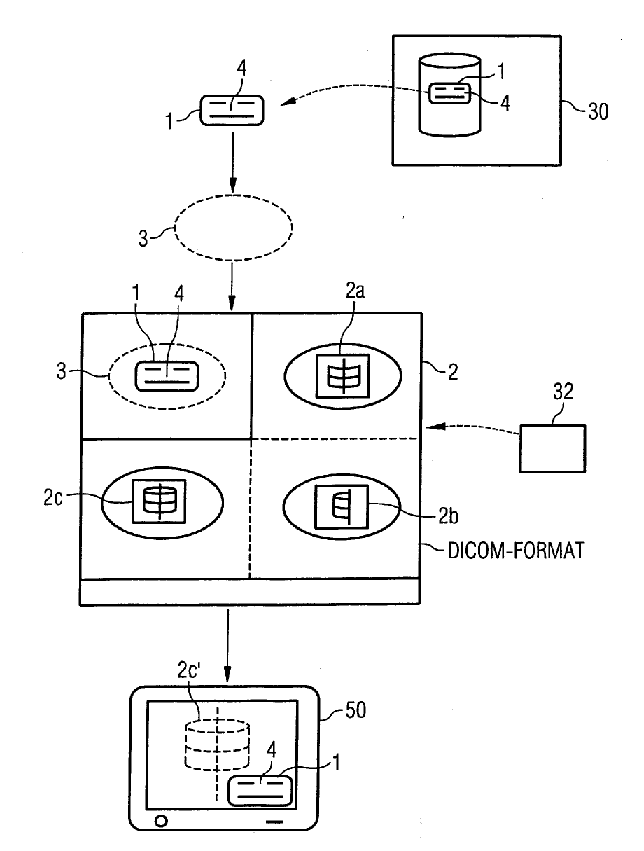

The data object 1 with the laboratory values 4 is stored in a database of the medical modality (i.e. the in vitro analysis apparatus 30) and exists in a DICOM-foreign data format. Alternatively, the data object 1 with the laboratory values 4 could also be stored on a central server of a hospital or a physician's practice (not shown in FIG. 1) which, for example, is located within a PACS system (not shown in FIG. 1) and can be reached online and nearly without time delay via a telecommunications system of the PACS system, i.e. via a network connection of the intranet. The data object 1 with the laboratory values 4 could likewise also be stored on a digital computer or storage medium which can be reached via the Internet.

Furthermore, a shadow group object 3 is presented in FIG. 1 as a further component of the inventive method. The shadow group object 3 is specified according to a DICOM standard and serves for integration of DICOM-foreign data into data sets or objects of the DICOM format.

Furthermore, a medical data set 2 which exists or is generated in the DICOM format is shown with an x-ray image series 2a, 2b, 2c of the chest region of a patient, wherein here the data object 1 is integrated into the medical data set 2 with the use of the shadow group object 3 via a section of the inventive method. In addition to the direct integration of the data object 1, the data object 1 could also first be correspondingly converted before the integration according to the method.

The x-ray image series 2a, 2b, 2c or, respectively, the medical data set 2 is acquired by a second medical modality represented in outline in the figure, which second medical modality is hereby an x-ray apparatus 32.

The integration of the shadow group object 3 into the medical data set 2 can thereby ensue during the generation of the medical data set 2 or also after its generation and storage on a digital storage medium (not shown in the FIGURE).

The in vitro analysis apparatus 30 is located in a laboratory, wherein the laboratory is spatially separated from the x-ray apparatus 32. The in vitro analysis apparatus 30 or the stored data object 1 is connected in terms of data with the x-ray apparatus 32 via a network connection.

According to the inventive method an integration of the DICOM-foreign data object 1 into the medical data set 2 which exists in the DICOM format ensues here (as already addressed) using or integrating the shadow group object 3 into the medical data set. The laboratory values 4 thus now integrated into the medical data set 2 or the x-ray image series 2a, 2b, 2c are used in a further course of the inventive method in order to control a process. The process relates to medical technology and (as shown in the FIGURE) includes, for example, the modified x-ray image display 2c′ of the previously acquired x-ray image 2c dependent on the laboratory values 4 as well as the display of the data object 1 or the laboratory values 4 contained therein on a display device (such as, for example, a screen 50).

The screen can thereby either be a separate screen 50 or a component of a data processing system (not shown in FIG. 1) connected to the x-ray apparatus 32 or a direct component of the x-ray apparatus 32.

According to the inventive method it is also alternatively possible to control a modified display of the medical data set as well as the operation of the x-ray apparatus 32 dependent on the data object 1 or the laboratory values 4 contained therein in order to enable the physician to generate an even faster and surer finding about the patient, for example. The reliability and quality of the finding can be inventively significantly improved.

According to the invention it is likewise possible to arbitrarily combine all further disclosed method sections with one another.

It will be apparent to those skilled in the art that the invention can be realized partially or wholly in software and/or hardware and/or distributed among a number of physical products (in particular computer program products).

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for integrating at least one data object in at least one medical data set, the data object and the medical data set both being associated with a patient examination, said method comprising the steps of:
formatting the medical data set according to a DICOM standard and formatting the data object according to a standard other than the DICOM standard;
integrating the data object into the medical data set through at least one shadow group object of the DICOM standard; and
controlling a procedure associated with the patient examination, selected from the group consisting of currently running procedures and planned procedures, dependent on the integrated data object.

2. A method as claimed in claim 1 comprising converting said data object from a first form to a second form before integrating said data object into the medical data.

3. A method as claimed in claim 1 comprising employing a shadow group object that encompasses said data object.

4. A method as claimed in claim 1 comprising linking the integrated data object with the medical data set.

5. A method as claimed in claim 1 comprising storing the integrated data object as a separate item from said medical data set.

6. A method as claimed in claim 1 comprising transferring the medical data set from a first location to a second location with the integrated data object as a separate object from the medical data set.

7. A method as claimed in claim 1 comprising employing, as said data object, at least one laboratory value.

8. A method as claimed in claim 1 comprising employing, as said medical data set, a medical image data set.

9. A method as claimed in claim 1 comprising employing, as said medical data set, a radiological data set.

10. A method as claimed in claim 1 comprising automatically visually displaying said integrated data object together with the medical data set.

11. A method as claimed in claim 1 comprising automatically electronically processing said integrated data object together with said medical data set.

12. A method as claimed in claim 11 comprising allowing modification of the integrated data object when processing said medical data set.

13. A method as claimed in claim 12 comprising automatically importing the integrated data object for said processing via an interface.

14. A device for integrating at least one data object in at least one medical data set, the data object and the medical data set both being associated with a patient examination, said device comprising:
a processor that receives a medical data set associated with a patient examination formatted according to a DICOM standard, and that formats a data object, also associated with the patient examination, according to a standard other than the DICOM standard;
said processor integrating the data object into the medical data set through at least one shadow group object of the DICOM standard; and
a control unit supplied with the integrated data object that controls a procedure associated with the patient examination, selected from the group consisting of currently running procedures and planned procedures, dependent on the integrated data object.

15. A medical system comprising:
a medical examination modality;
a processor that receives a medical data set associated with a patient examination formatted according to a DICOM standard, and that formats a data object, also associated with the patient examination, according to a standard other than the DICOM standard;
said processor integrating the data object into the medical data set through at least one shadow group object of the DICOM standard; and
a control unit supplied with the integrated data object that controls said medical examination modality to execute a procedure associated with the patient examination, selected from the group consisting of currently running procedures and planned procedures, dependent on the integrated data object.

16. A computer-readable medium encoded with computer-executable instructions for integrating at least one data object in at least one medical data set, the data object and the medical data set both being associated with a patient examination, said instructions, when said medium is loaded into a computer, causing the computer to:
receive the medical data set formatted according to a DICOM standard and format the data object according to a standard other than the DICOM standard;
integrate the data object into the medical data set through at least one shadow group object of the DICOM standard; and
control a procedure associated with the patient examination, selected from the group consisting of currently running procedures and planned procedures, dependent on the integrated data object.
